(19) United States
(12) Patent Application Publication
(10) Pub. No.: US 2026/0162321 A1
(43) Pub. Date: Jun. 11, 2026

(54) THERMAL RESOLUTION ENHANCEMENTS USING ARTIFICIAL INTELLIGENCE AND SPECTRAL EMISSIONS

(71) Applicant: Microsoft Technology Licensing, LLC, Redmond, WA (US)

(72) Inventors: Curtis Alan TESDAHL, Fort Collins, CO (US); Kevin James MATHERSON, Windsor, CO (US); David Andrew DORN, Loveland, CO (US)

(21) Appl. No.: 18/971,937

(22) Filed: Dec. 6, 2024

(51) Int. Cl. G06T 11/00; G06V 20/00

(52) U.S. Cl. CPC G06T 11/10; G06V 20/39

(57) ABSTRACT

A service obtains a readout of a thermal imaging sensor, which includes multiple different sets of pixels. Each set of pixels captures a different corresponding range of wavelengths of LWIR light. The service generates a number of images using the readout. Each image reflects a same scene using a corresponding one of the different ranges of wavelengths of the LWIR light. The service identifies, within the images, an object. The service uses the images to identify an LWIR profile for the object. The service determines a type of the object by matching the identified LWIR profile with a previously saved LWIR profile established for objects of that type. The service colorizes a different thermal image of the scene. Colorizing the different thermal image includes colorizing the object as represented within that scene based on the determined type for the object.

### BACKGROUND

Head mounted devices (“HMDs”), or other wearable devices, are becoming highly popular. These types of devices are able to provide a so-called “extended reality” experience.

The phrase “extended reality” (“ER”) is an umbrella term that collectively describes various different types of immersive platforms. Such immersive platforms include virtual reality (“VR”) platforms, mixed reality (“MR”) platforms, and augmented reality (“AR”) platforms. The ER system provides a “scene” to a user. As used herein, the term “scene” generally refers to any simulated environment (e.g., three-dimensional (“3D”) or two-dimensional (“2D”)) that is displayed by an ER system.

For reference, conventional VR systems create completely immersive experiences by restricting their users' views to only virtual environments. This is often achieved using an HMD that completely blocks any view of the real world. Conventional AR systems create an augmented-reality experience by visually presenting virtual objects that are placed in the real world. Conventional MR systems also create an augmented-reality experience by visually presenting virtual objects that are placed in the real world, and those virtual objects are typically able to be interacted with by the user. Furthermore, virtual objects in the context of MR systems can also interact with real world objects. AR and MR platforms are often implemented using an HMD. ER systems can also be implemented using laptops, handheld devices, HMDs, and other computing systems.

Unless stated otherwise, the descriptions herein apply equally to all types of ER systems, which include MR systems, VR systems, AR systems, and/or any other similar system capable of displaying virtual content. An ER system can be used to display various types of information to a user. Some of that information is displayed in the form of a “hologram.” As used herein, the term “hologram” generally refers to image content that is displayed by an ER system. In some instances, the hologram can have the appearance of being a 3D object while in other instances the hologram can have the appearance of being a 2D object. In some instances, a hologram can also be implemented in the form of an image displayed to a user.

Continued advances in hardware capabilities and rendering technologies have greatly increased the realism of holograms and scenes displayed to a user within an ER environment. For example, in ER environments, a hologram can be placed within the real world in such a way as to give the impression that the hologram is part of the real world. As a user moves around within the real world, the ER environment automatically updates so that the user is provided with the proper perspective and view of the hologram. This ER environment is the “scene” mentioned previously.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a method including: obtaining a readout of a thermal imaging sensor, wherein the thermal imaging sensor includes a plurality of different sets of pixels, and wherein each respective set of pixels captures a different corresponding range of wavelengths of long-wave infra-red (LWIR) light; generating a number of images using the readout, wherein each one of the images reflects a same scene using a corresponding one of the different ranges of wavelengths of the LWIR light; identifying, within one or more of the images, an object that is represented in at least some of the images and is represented across at least some of the different ranges of wavelengths; using one or more of the images, which reflect the different ranges of wavelengths, to identify an LWIR profile for the object; determining a type of the object by matching the identified LWIR profile with a previously saved LWIR profile established for objects of that type; and colorizing a different thermal image of the scene, wherein colorizing the different thermal image of the scene includes colorizing the object as represented within that scene based on the determined type for the object.

In some aspects, the techniques described herein relate to a computer system including: a processor system; and a storage system that stores instructions that are executable by the processor system to cause the computer system to: obtain a readout of a thermal imaging sensor, wherein the thermal imaging sensor includes a plurality of different sets of pixels, and wherein each respective set of pixels captures a different corresponding range of wavelengths of long-wave infra-red (LWIR) light; generate a number of images using the readout, wherein each one of the images reflects a same scene using a corresponding one of the different ranges of wavelengths of the LWIR light; identify, within one or more of the images, an object that is represented in at least some of the images and is represented across at least some of the different ranges of wavelengths; use one or more of the images, which reflect the different ranges of wavelengths, to identify an LWIR profile for the object; determine a type of the object by matching the identified LWIR profile with a previously saved LWIR profile established for objects of that type; and colorize a different thermal image of the scene, wherein colorizing the different thermal image of the scene includes colorizing the object as represented within that scene based on the determined type for the object.

In some aspects, the techniques described herein relate to an extended reality (ER) system including: a processor system; and a storage system that stores instructions that are executable by the processor system to cause the ER system to: obtain a readout of a thermal imaging sensor, wherein the thermal imaging sensor includes a plurality of different sets of pixels, and wherein each respective set of pixels captures a different corresponding range of wavelengths of long-wave infra-red (LWIR) light; generate a number of images using the readout, wherein each one of the images reflects a same scene using a corresponding one of the different ranges of wavelengths of the LWIR light; identify, within one or more of the images, an object that is represented in at least some of the images and is represented across at least some of the different ranges of wavelengths; use one or more of the images, which reflect the different ranges of wavelengths, to identify a LWIR profile for the object; determine a type of the object by matching the identified LWIR profile with a previously saved LWIR profile established for objects of that type; and colorize a different thermal image of the scene, wherein colorizing the different thermal image of the scene includes colorizing the object as represented within that scene based on the determined type for the object.

The disclosed embodiments can beneficially incorporate the use of artificial intelligence (AI) and other machine learning (ML) implementations. These ML models can be trained and subsequently fine-tuned to perform specific operations. By way of example and not limitation, the ML models can be trained to extract subtle spectrum differences in the resulting images to distinguish between objects in the scene. Performing these operations improves the detectability of objects within the scene and also improves how those objects are classified. Additionally, the disclosed embodiments can be implemented using a diffractive optical element (e.g., a monolithic lenslet array), a meta-surface lenslet (e.g., a meta-lens), and/or a wafer-molded lenslet array.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computing architecture configured to intelligently classify objects in a thermal image.

FIGS. 2A, 2B, 2C, 2D, 2E, and 2F illustrate examples of an apparatus that is structured to generate improved thermal imagery.

FIGS. 3A and 3B illustrate various different aspects of the apparatus.

FIG. 4 illustrates examples of different types of grid-like patterns.

FIG. 5 illustrates examples of pillars that form a point spread function similar to how a lens focuses light.

FIG. 6 illustrates examples of the structural configuration of the apparatus.

FIG. 7 illustrates different thermal images that are produced when the apparatus is used.

FIG. 8 illustrates an example of an LWIR profile for an object detected in thermal images.

FIG. 9 illustrates an example of a scene image.

FIG. 10 illustrates an example of a colorized image.

FIG. 11 illustrates a flowchart of an example method for intelligently identifying objects in a thermal image and for generating a colorized thermal image.

FIG. 12 illustrates an example of a computer system that can be configured to perform any of the disclosed operations.

### DETAILED DESCRIPTION

Infrared (“IR”) thermography, or “thermal imaging,” refers to a process in which a specialized type of camera (i.e. a “thermal camera”) generates an image of a scene using IR radiation that is being emitted from the scene. In the past few years, ER systems have been equipped with thermal cameras. With a combination of both a visible light camera and a thermal camera, the ER system can provide enhanced imagery to the user. For instance, not only can the user perceive content in the visible light spectrum, but the user can now also perceive content in the thermal spectrum.

There are various challenges to equipping an ER system with a thermal camera, however. As one example, the form factor of traditional thermal cameras is quite large. When disposed on a head mounted ER system, the weight, bulky size, and form factor of the thermal camera can imbalance the ER system, perhaps leading to discomfort on the user's part. Thermal cameras can also consume a large portion of the ER system's battery budget. Yet another challenge relates to the resulting resolution of the thermal image. Traditionally, it has been a challenge to distinguish content in a thermal image due to the blending of spectral signatures in the scene. Previous attempts at using machine learning (“ML”) to help with the distinction have largely not been successful.

The disclosed embodiments bring about numerous benefits, advantages, and practical applications to the field of extended reality. In particular, the disclosed embodiments improve thermal imaging resolution by breaking the Long-Wave Infra-Red (“LWIR”) atmospheric band into smaller emission sub-bands or “colors.” These sub-bands (aka “sub-wavebands”) are combined by an Artificial Intelligence (“AI”) engine (aka an “ML engine”) to segregate those sub-bands into various materials that have recognizable profiles (e.g., rocks, trees, leaves, carpet, drywall, etc.). LWIR light is both reflected and emitted by objects. When reference is made herein to “reflected” LWIR light, it should also be appreciated how the objects can emit LWIR light.

The embodiments also allow for the detection and classification of materials (including hazardous ones) by extracting subtle spectral signatures in the material's emissions. Differentiation of objects in low contrast “blurred” scenes can be improved by separating the objects in the scene from each other based on these signatures.

The spectral separation is implemented in at least some embodiments via the use of an improved focusing element that operates in conjunction with a single thermal imaging sensor and an AI engine. The AI engine extracts image spectral emission features across the arrays. This approach improves how thermal applications operate, particularly for ER systems. Also, the embodiments configure the structure of the disclosed array in a manner resulting in a reduced z-profile as compared to traditional thermal sensors. With this reduced z-profile, the embodiments address the weight, size, and balancing issues mentioned earlier.

As mentioned above, if a traditional lens were to be used, that traditional lens would lead to significant size and cost disadvantages for the ER system. Also, with traditional approaches, multiple cameras were needed or a single camera with a filter wheel was required. In contrast, by using a monolithic lenslet array (i.e. flat surfaced lenslet array), the size of the unit can be reduced. The disclosed array can be composed of any number of molded wafer-level optics or from a metamaterial fabrication flow. The monolithic lenslet array, which can also be referred to as a diffractive optical element (DOE) or as comprising multiple DOEs, is structured to mimic the performance of a traditional lens.

A DOE uses the principle of diffraction to control light. A DOE has a micro-structured pattern on its surface, and that pattern alters the phase of incoming light waves, thereby enabling functions like beam splitting, focusing, and shaping light into specific intensity profiles. Regarding the design of a DOE, these types of elements are typically designed with precise patterns that cause light to interfere constructively or destructively, creating the desired optical effect. DOEs are used in various applications, including laser beam shaping, holography, and optical data storage.

The disclosed embodiments can also incorporate the use of a meta-lens and/or a wafer-molded lens. Meta-lenses use meta-surfaces composed of subwavelength structures called meta-atoms to manipulate light. These meta-atoms modify the phase profile of incident light, allowing the meta-lens to focus or redirect light in a manner similar to traditional lenses but with a flat, thin structure. The meta-atoms are designed to locally control one or more of the phase, the amplitude, or the polarization of light via the arrangement of pillars. This allows meta-lenses to achieve complex wavefront engineering in a single, compact element. Meta-lenses are used in applications where size and weight are relevant, such as in smartphone cameras, AR/VR systems, medical devices, and advanced imaging systems. The meta-lens used herein includes various different pillars to focus light. Further details on these pillars will be described in more detail later.

The operation of a DOE and a meta-lens differ primarily in how they manipulate light. For instance, a DOE relies on diffraction patterns to manipulate light, while a meta-lens uses subwavelength meta-atoms to achieve phase control. DOEs also typically have micro-structured patterns, whereas meta-lenses have nanoscale meta-atoms arranged on a flat surface. Meta-lenses can combine multiple optical functions (e.g., focusing, polarization control) into a single element, offering more versatility compared to traditional DOEs.

Both technologies represent advanced methods of controlling light, but they are optimized for different applications and offer unique advantages based on their underlying principles. A meta-lens, as will be discussed in more detail later, may include any number of pillars. These pillars are typically sub-wavelength whereas DOEs operate on the wavelength level. In at least some embodiments, the different pillars are arranged in a specific manner so as to focus light onto a specific region, similar to how a lens operates and similar to a point spread function. This focusing of light can be achieved via use of the pillars, which are arranged in a flat surface, thereby achieving the reduced z-profile. As mentioned above, pillars typically operate at sub-wavelengths while diffractive optical elements typically operate on the wavelength level.

In the disclosed embodiments, IR lenslets (e.g., any of the DOEs, meta-lenses, or wafer-molded lenses described herein) range in size from several millimeters to a centimeter depending on the application. In some scenarios, the size may be larger than one centimeter. Typically, however, the size will be smaller than one centimeter because these units are often incorporated as a part of an ER system. IR lens sizes are sensor-size dependent. The z-height is proportional to the focal length and field of view. Larger fields of view have shorter focal lengths. The covering power of the lens is proportional to the half diagonal of the sensor. Paraxially, for an infinitely distant object, the image height is given by h′=f*tan(theta), where f is the focal length, and theta is object field angle.

Meta-lenses are promising for use in compact imaging systems because they can be created using photolithography and can be made very small. Often, meta-lenses have a thickness of about several microns to multiple tens of microns. Spatially, in the x-y plane, meta-lenses vary from hundreds of microns to centimeters (e.g., when they are trying to replace large optical elements). It depends on the wavelength, focal length, and other parameters.

The disclosed embodiments can accommodate both lens-like types (e.g., molded wafer-level optics and metamaterial) because the spectrum is segregated and because AI algorithms are utilized in the extraction process. Use of the AI engine helps remove non-essential image information.

As another benefit, an AI algorithm is trained on a variety of common materials under a variety of scenes. As an example of an outdoor scene, the AI algorithm can be trained to differentiate between rocks, grass, trees, water, and so on. For indoor scenes, the AI algorithm can be trained to differentiate between carpet, drywall, paint, wood, and so on. Another example relates to the training of the AI algorithm to specific emissive signatures of a harmful gas or liquid. This contextual environmental training can allow for the implementation of a small AI footprint. Thus, the AI algorithm can be fine-tuned to operate more efficiently for specific environmental types.

The information produced by the AI algorithm can be displayed or further processed. In the case of a display, the spectral information can be directly mapped in a linear fashion onto the ER system's display. Additionally, or alternatively, the information can be used to classify objects in the scene and color those objects differently than other objects. For example, rocks can have one color, and water can have a different color. If further processed, the data can be used to trigger warnings for hazardous materials or to help the user identify objects in the scene.

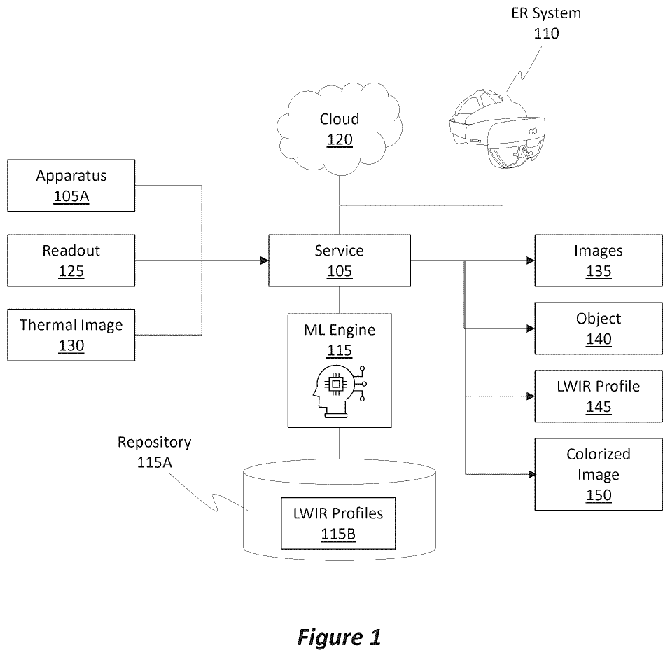

Having just described some of the high level benefits, advantages, and practical applications achieved by the disclosed embodiments, attention will now be directed to FIG. 1, which illustrates an example computing architecture 100 that can be used to achieve those benefits. Architecture 100 includes a service 105, which can be implemented by an ER system 110 comprising an HMD. Service 105 operates in close conjunction with an apparatus 105A, which will be described in more detail later.

As used herein, the phrases ER system, HMD, ER platform, ER device, or wearable device can all be used interchangeably and generally refer to a type of system that displays holographic content (e.g., “holograms” or “virtual stimuli”). In some cases, ER system 110 is of a type that allows a user to see various portions of the real world and that also displays virtualized content in the form of holograms. That ability means ER system 110 is able to provide so-called “passthrough images” to the user. It is typically the case that architecture 100 is implemented on an MR or AR system, though it can also be implemented in a VR system.

As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine, such as ML engine 115. The ML engine 115 enables the service to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a cloud service operating in a cloud 120 environment. In some implementations, service 105 is a local service operating on a local device, such as the ER system 110. In some implementations, service 105 is a hybrid service that includes a cloud component operating in the cloud 120 and a local component operating on a local device. These two components can communicate with one another.

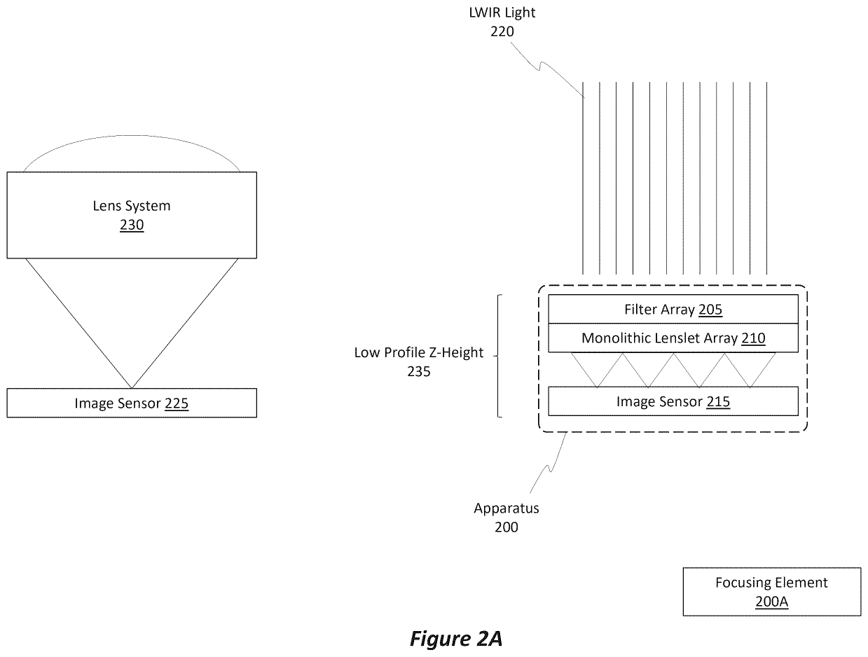

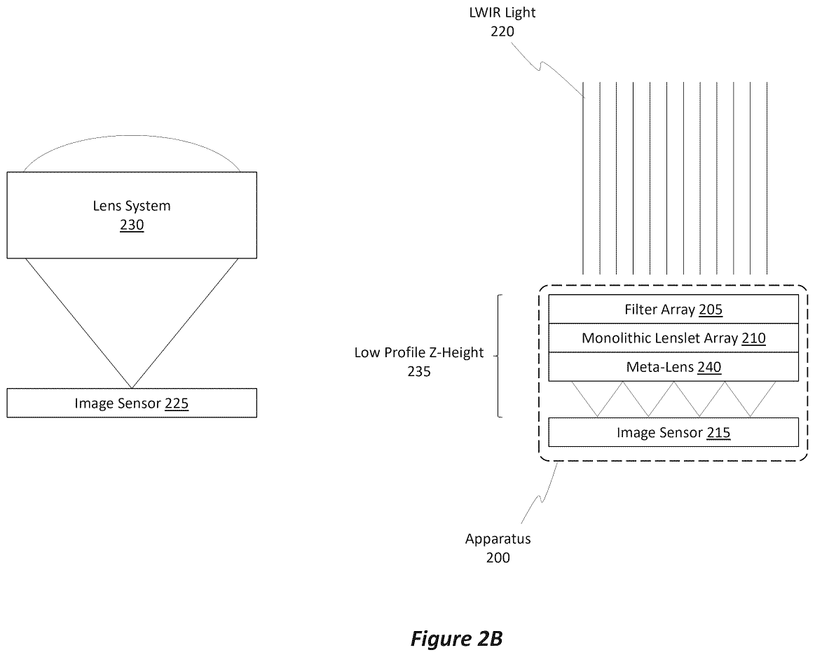

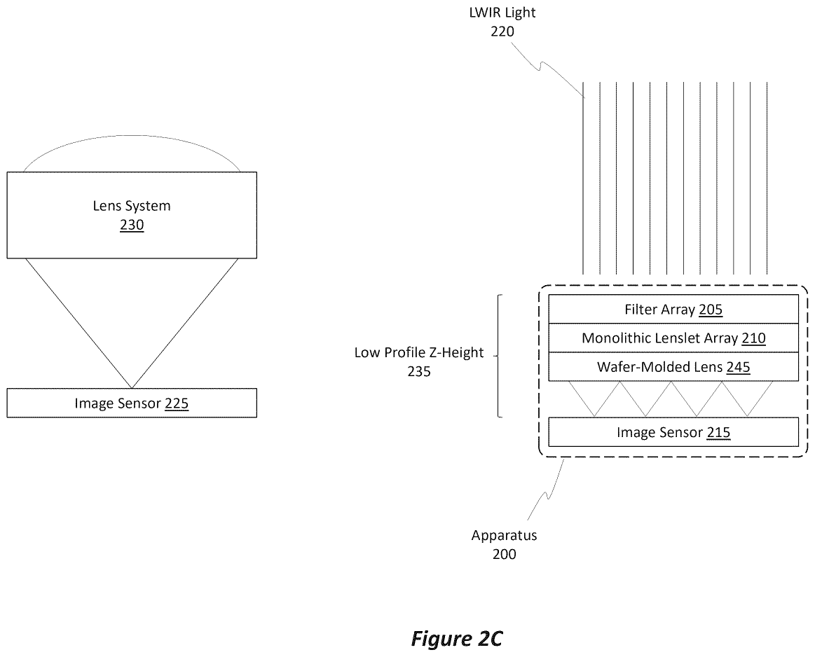

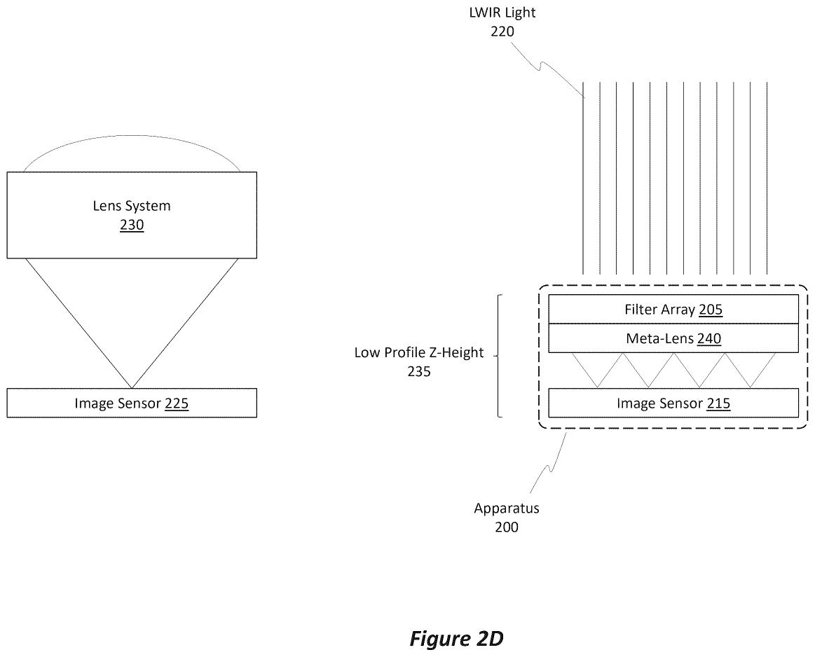

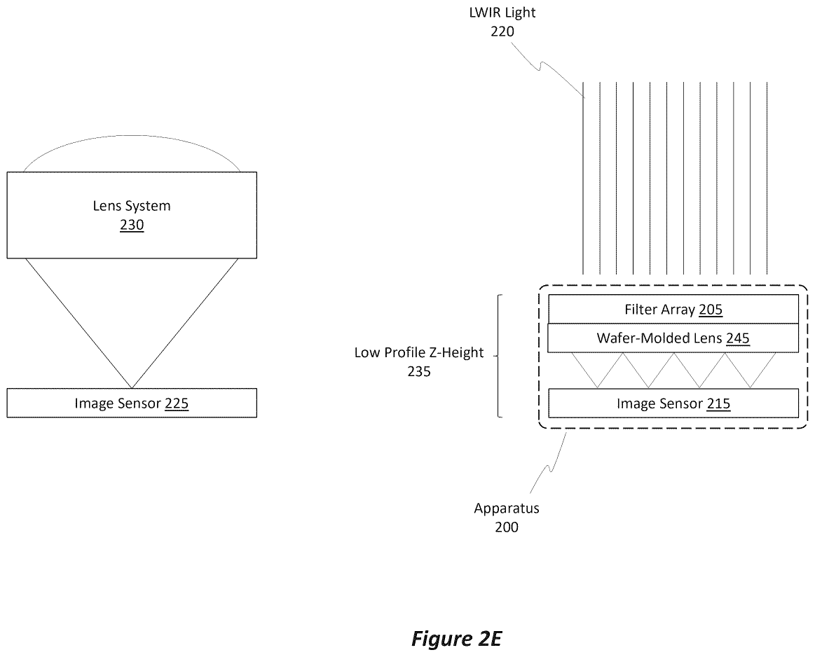

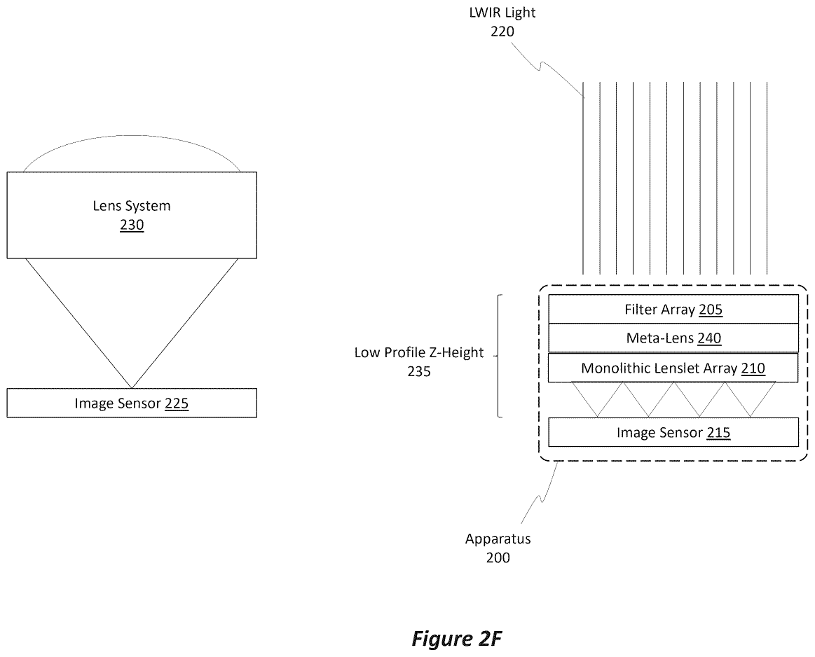

Service 105 is generally tasked with facilitating the use of the apparatus 105A, which is structured to disperse LWIR light having wavelengths spanning about 8 microns to about 14 microns into multiple sub-wavebands via that use of a monolithic (e.g., flat surfaced) lenslet array. This lenslet array has a low-profile z-height and has lenslets that are substantially immediately proximate to one another (e.g., various portions of each lenslet can abut or contact corresponding portions of a neighboring lenslet). The lenslet array also operates on the LWIR light in a spatial and spectral manner to facilitate imaging of the LWIR light. It should be noted that while a majority of this disclosure is focused on the scenario involving LWIR light, the disclosed principles can also be employed when operating on other wavelength ranges, such as the far IR range. Service 105 is further tasked with feeding the imaging output from the apparatus 105A to the ML engine 115 for further processing. FIGS. 2A, 2B, 2C, 2D, and 2E provide additional clarification regarding the apparatus 105A of FIG. 1.

Turning to FIG. 2A, FIG. 2A shows an apparatus 200 that is representative of the apparatus 105A used by service 105. Apparatus 200 is shown as including a filter array 205, a monolithic lenslet array 210 (aka a DOE or rather, an array of DOEs), and an image sensor 215. LWIR light 220 is received by the apparatus 200. The image sensor 215 is a thermal imaging sensor that is capable of reading the LWIR light 220. The monolithic lenslet array 210 (i.e. a DOE) can be included as a part of a focusing element 200A. As will be described in more detail later, the focusing element 200A may include any one or more of the monolithic lenslet array 210, a meta-lens, and/or a wafer-molded lens. In more specific configurations, the focusing element 200A may include only the monolithic lenslet array 210, or only the meta-lens, or only the wafer-molded lens. As other configurations, the focusing element 200A may include a combination of the monolithic lenslet array 210 and the meta-lens or, alternatively, a combination of the monolithic lenslet array 210 and the wafer-molded lens.

FIG. 2A also shows a traditional array unit, which includes an image sensor 225 and a lens system 230. Notice, the low profile z-height 235 of the apparatus 200 as compared to the z-height of the traditional lens units. In some embodiments, at least a 50% reduction in z-height (as compared to the traditional unit) can be achieved using the apparatus 200. In some scenarios, a 75% reduction in z-height (as compared to the traditional unit) can be achieved using the apparatus 200. Thus, for example, the z-height of the apparatus 200 is approximately 25% of the height of traditional units. This reduction is achieved because the monolithic lenslet array 210 is a planar or flat surface that can focus light in a similar manner as the curved lens system 230. Both meta-lenses and DOEs are considered as “flat” optics, and this flatness helps reduce the overall z-height of the apparatus 200.

Regarding the filter array 205, this filter array 205 includes a plurality of optical bandpass filters arranged in a grid-like pattern or a regular pattern. Each optical bandpass filter in the filter array is structured to spectrally split the LWIR light into a corresponding sub-waveband. Optionally, the filter array can be structured using stripe filters as opposed to a grid configuration. The combination of each corresponding sub-waveband forms the plurality of sub-wavebands. Also, the plurality of sub-wavebands covers at least a majority of the wavelengths of the LWIR light. For example, at least 50% of the spectrum of LWIR light can be filtered using the filter array 205. Often, the amount of LWIR that is filterable is significantly more than 50%, such as 75%, 80%, 85%, 90%, 95%, or more than 95%. Stated differently, the filter array 205 is structured in a manner such that often at least 95% of the LWIR spectrum is usable and will be passed to the image sensor 215. In some scenarios, 100% of the LWIR spectrum is usable and is passed to the image sensor 215.

FIGS. 2B through 2F illustrate other example implementations. FIG. 2B shows an implementation involving the use of a combination of the monolithic lenslet array 210 and a meta-lens 240, which is structured to have the various different pillars mentioned earlier. These pillars will be discussed in more detail shortly.

FIG. 2C shows an implementation involving the use of a combination of the monolithic lenslet array 210 and a wafer-molded lens 245. FIG. 2D shows an implementation that omits the monolithic lenslet array 210 and that includes the meta-lens 240. FIG. 2E shows an implementation that also omits the monolithic lenslet array 210 and that includes the wafer-molded lens 245. FIG. 2F shows an implementation where the meta-lens 240 is disposed on top of (in a z vertical direction) the monolithic lenslet array 210. Alternatively, the wafer-molded lens 245 can also be disposed on top of the monolithic lenslet array 210. The structural configurations of the units can be modified to accommodate different refractive effects of whichever unit is positioned on top. Thus, various different structural configurations are supported by the disclosed embodiments. The focusing element 200A shown in FIG. 2A may include any one or more of the monolithic lenslet array 210, the meta-lens 240, and/or the wafer-molded lens 245.

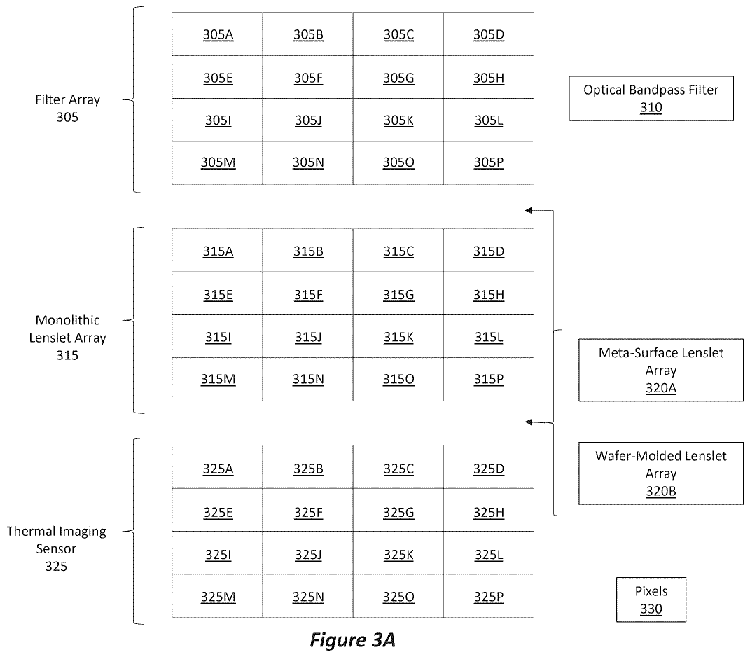

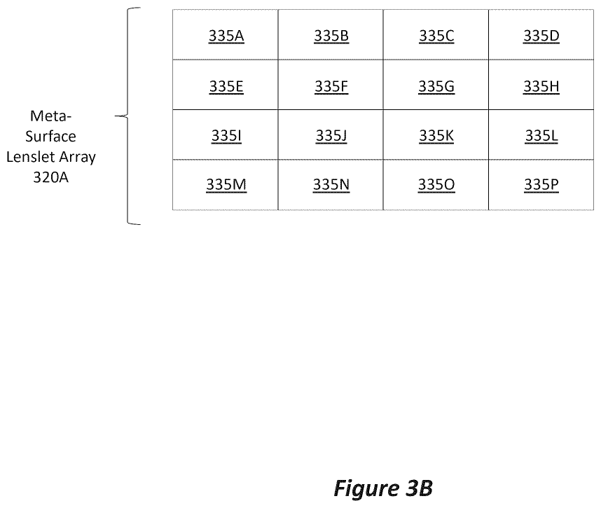

FIG. 3A shows a filter array 305 that is representative of the filter array 205 of FIG. 2A. Notice, the filter array 305 is organized into a grid-like pattern and includes multiple bandpass filters, as shown by bandpass filters 305A, 305B, 305C, 305D, 305E, 305F, 305G, 305H, 305I, 305J, 305K, 305L, 305M, 305N, 305O, and 305P. Optical bandpass filter 310 is thus representative of these various different optical bandpass filters.

Each individual one of the optical bandpass filters is structured to spectrally split the LWIR light into a corresponding sub-waveband. For instance, each one of the optical bandpass filters can be configured to pass a specific range of LWIR light through, and that range can be set to any value. As one example, the range may be set to a value of 250 nanometers (nm).

For instance, filter 305A can pass LWIR light falling within the range of 8-8.25 microns. Filter 305B can pass LWIR light falling within the range of 8.25-8.5 microns. Filter 305C can pass LWIR light falling within the range of 8.5-8.75 microns. Filter 305D can pass LWIR light falling within the range of 8.75-9 microns. Filter 305E can pass LWIR light falling within the range of 9-9.25 microns. Filter 305F can pass LWIR light falling within the range of 9.25-9.5 microns. Filter 305G can pass LWIR light falling within the range of 9.5-9.75 microns. Filter 305H can pass LWIR light falling within the range of 9.75-10 microns. Filter 305I can pass LWIR light falling within the range of 10-10.25 microns. Filter 305J can pass LWIR light falling within the range of 10.25-10.5 microns. Filter 305K can pass LWIR light falling within the range of 10.5-10.75 microns. Filter 305L can pass LWIR light falling within the range of 10.75-11 microns. Filter 305M can pass LWIR light falling within the range of 11-11.25 microns. Filter 305N can pass LWIR light falling within the range of 11.25-11.5 microns. Filter 305O can pass LWIR light falling within the range of 11.5-11.75 microns. Filter 305P can pass LWIR light falling within the range of 11.75-12 microns.

In some embodiments, the entire range of wavelengths of the LWIR light can be covered by the filter array 305. In other embodiments, however (such as the one described above), a substantial majority, but not necessarily the entirety, of the LWIR light can be covered. In the above example, only the wavelengths ranging from 8 microns to 12 microns are covered.

Notice also, in some embodiments, the filters are configured in a manner so as to contiguously cover the wavelengths in the LWIR light. For instance, filter 305A covers from 8 microns to 8.25 microns, and then filter 305B covers from 8.25 microns to 8.5 microns. Thus, filters 305A and 305B are contiguous relative to one another.

In some embodiments, the plurality of sub-wavebands formed by the filter array 305 covers some, but not all, of the wavelengths of the LWIR light. In some embodiments, the plurality of sub-wavebands formed by the filter array 305 covers all of the wavelengths of the LWIR light.

The wavelengths of the LWIR light covered by the plurality of sub-wavebands can, in some scenarios, be covered equally among the sub-wavebands (e.g., an equal range is used by each of the filters 305A-305P). Stated differently, each of the sub-wavebands formed by the filter array 305 can cover a corresponding range of wavelengths, and each of the range of wavelengths has an equal range.

On the other hand, in some implementations, the range of wavelengths covered by each individual one of the optical bandpass filters in the filter array 305 can be different. For instance, one or more of the filters can cover a first range of wavelengths (e.g., perhaps 250 nm) while one or more other filters can cover a second range of wavelengths (e.g., perhaps 300 nm). Any number of different variations can be used.

The grid-like pattern of the filter array 305 may include a first row of multiple optical bandpass filters, as shown in FIG. 3A. Optical bandpass filters in the first row can be structured to spectrally split the LWIR light in a contiguous manner from a first optical bandpass filter in the first row (e.g., filter 305A) to a last optical bandpass filter in the first row (e.g., filter 305D). For instance, bandpass filters 305A, 305B, 305C, and 305D spectrally split the LWIR light in a contiguous manner (e.g., perhaps from 8 microns starting at filter 305A to 9 microns ending at filter 305D, as in the example presented earlier).

The grid-like pattern of the filter array may further include a second row of multiple optical bandpass filters (e.g., filters 305E to 305H). Each optical bandpass filter in the second row can also be structured to spectrally split the LWIR light in a contiguous manner across the second row. For instance, using the earlier example, filters 305E-305H may spectrally split the LWIR light in a contiguous manner from 9 microns up to 10 microns.

A third row and a fourth row can also be implemented in a similar contiguous manner. Notably, any number of rows can be used, and the embodiments are not limited to a specific number of rows or columns.

Continuing with the above example, a last optical bandpass filter included in the first row spectrally splits the LWIR light from a first starting wavelength to a first ending wavelength. For instance, consider filter 305D, which is the last filter in the first row. In the earlier example, filter 305D filters the LWIR light across the range of 8.75 microns to 9 microns.

Optionally, a first optical bandpass filter included in the second row spectrally splits the LWIR light from a second starting wavelength to a second ending wavelength. The second starting wavelength of the first optical bandpass filter in the second row can be the same as the first ending wavelength of the last optical bandpass filter in the first row. For instance, consider filter 305E, which filters light (in one example) from 9-9.25 microns.

Filter 305E is a first optical bandpass filter included in the second row. Filter 305E filters light from a second starting wavelength (e.g., 9 microns) to a second ending wavelength (e.g., 9.25 microns). Notice, the second starting wavelength (e.g., 9 microns) of the first optical bandpass filter in the second row (i.e. filter 305E) is the same as the first ending wavelength (e.g., 9 microns) of the last optical bandpass filter in the first row (i.e. filter 305D). Thus, spectral splitting can occur in a contiguous manner within a row and can restart in a next row of optical bandpass filters.

The above example focused on a scenario where the range continued starting at the first filter in each succeeding row. In some cases, the range can continue starting at the last filter in the succeeding row and continue to progress from right to left in a back-and-forth manner. Thus, the ranges can be covered along one row from left to right, immediately drop to the next row, and proceed to be covered from right to left. Then, the range can drop down to the next filter in the next row and again proceed from left to right in a back-and-forth manner as opposed to a reset-on-each-row manner.

In another example, the grid-like pattern of the filter array may include a first column of multiple optical bandpass filters. Optionally, optical bandpass filters in the first column spectrally split the LWIR light in a contiguous manner from a first optical bandpass filter in the first column to a last optical bandpass filter in the first column. The range can continue starting at the top (or bottom) of the next column. Thus, instead of splitting light in a contiguous manner along a row, light can be split in a contiguous manner along a column. Light can also be split in a contiguous manner in a diagonal manner as well.

Returning to FIG. 3A, a monolithic lenslet array 315 is shown. The monolithic lenslet array 315 is representative of the monolithic lenslet array 210 of FIG. 2. The monolithic lenslet array 315 is a type of DOE that operates in a manner similar to a lens.

The monolithic lenslet array 315 includes a plurality of lenslets (e.g., lenslets 315A, 315B, 315C, 315D, 315E, 315F, 315G, 315H, 315I, 315J, 315K, 315L, 315M, 315N, 315O, and 315P) also arranged in the grid-like pattern. Notably, the monolithic lenslet array 315 is aligned with the filter array 305 such that each optical bandpass filter in the filter array is aligned with a corresponding lenslet in the plurality of lenslets. For instance, lenslet 315A is disposed underneath and is covered by filter 305A. Similarly, lenslet 315B is disposed underneath and is covered by filter 305B, and so on. Thus, filter 305A filters a specific spectrum of the LWIR light and allows only that filtered light to pass to lenslet 315A. Similar filtering occurs for filter 305B and lenslet 315B.

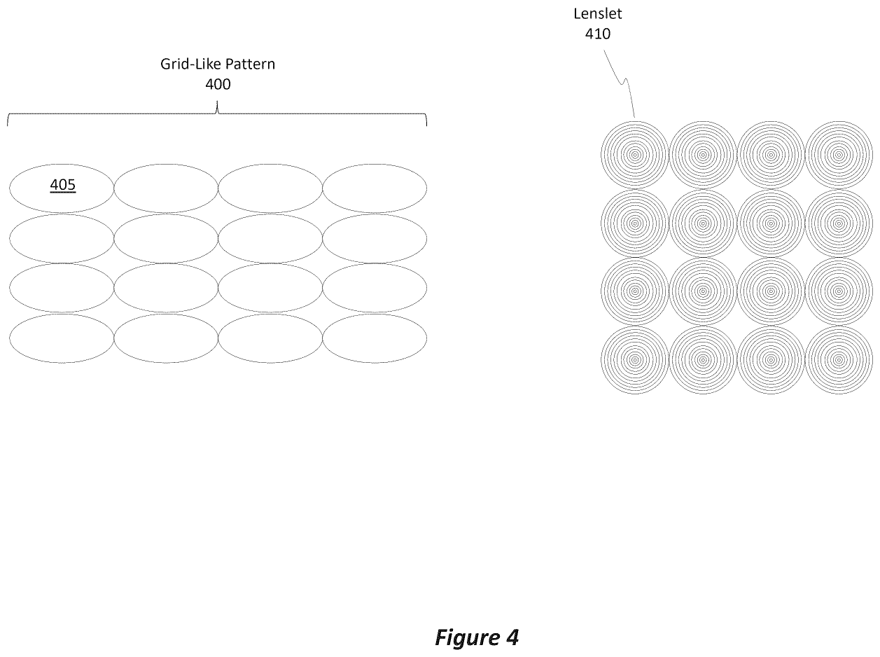

Regarding the grid-like pattern, FIG. 4 shows one example of a grid-like pattern 400 that can be used by the filter array and the monolithic lenslet array. Notice, the grid-like pattern 400 is generally structured to include elliptical, ovular, or circular elements, such as element 405. Any shape can be used, however, including rectangular, square shapes, or hexagonal shapes, which are particularly beneficial because they help significantly eliminate gaps between the different portions. Notice further, each element in the grid-like pattern 400 immediately abuts or is immediately proximate to at least one other element in the grid.

FIG. 4 also shows the pattern for the lenslets, as shown by lenslet 410, which is included in the monolithic lenslet array. As one option, the grid-like pattern of the monolithic lenslet array can be a 4 lenslet by 4 lenslet pattern, and the grid-like pattern of the filter array can be a 4 optical bandpass filter by 4 optical bandpass filter pattern. Of course, any number of elements can be used, without limit.

Returning to FIG. 3A, each lenslet in the plurality of lenslets is structured to operate in a manner similar to how a diffractive optical element operates. DOEs use the principle of diffraction to control light. For example, they can have micro-structured patterns on their surface that alter the phase of incoming light waves, enabling functions like beam splitting, focusing, and shaping light into specific intensity profiles. These elements are typically designed with precise patterns that cause light to interfere constructively or destructively, creating the desired optical effect.

FIG. 3A also shows a meta-surface lenslet array 320A and a wafer-molded lenslet array 320B (which can also be referred to as a fly's eye). Both of these arrays also operate in a manner similar to a lens. The meta-surface lenslet array 320A and the wafer-molded lenslet array 320B are shown as being disposed between the filter array 305 and the thermal imaging sensor 325. In some scenarios, they are disposed between the monolithic lenslet array 315 and the thermal imaging sensor 325. In alternative scenarios, they are disposed between the filter array 305 and the monolithic lenslet array 315. The meta-surface lenslet array 320A corresponds to the meta-lens 240 shown in FIG. 2B, and the wafer-molded lenslet array 320B corresponds to the wafer-molded lens 245 of FIG. 2C.

The meta-surface lenslet array 320A use meta-surfaces composed of subwavelength structures called meta-atoms to manipulate light. These meta-atoms modify the phase profile of incident light, allowing the meta-lens to focus or redirect light in a manner similar to traditional curved lenses but with a flat, thin structure, that is, the meta-lens is “flat” relative to a traditionally curved lens. The meta-atoms are designed to locally control one or more of the phase, amplitude, or polarization of light. This allows meta-lenses to achieve complex wavefront engineering in a single, compact element.

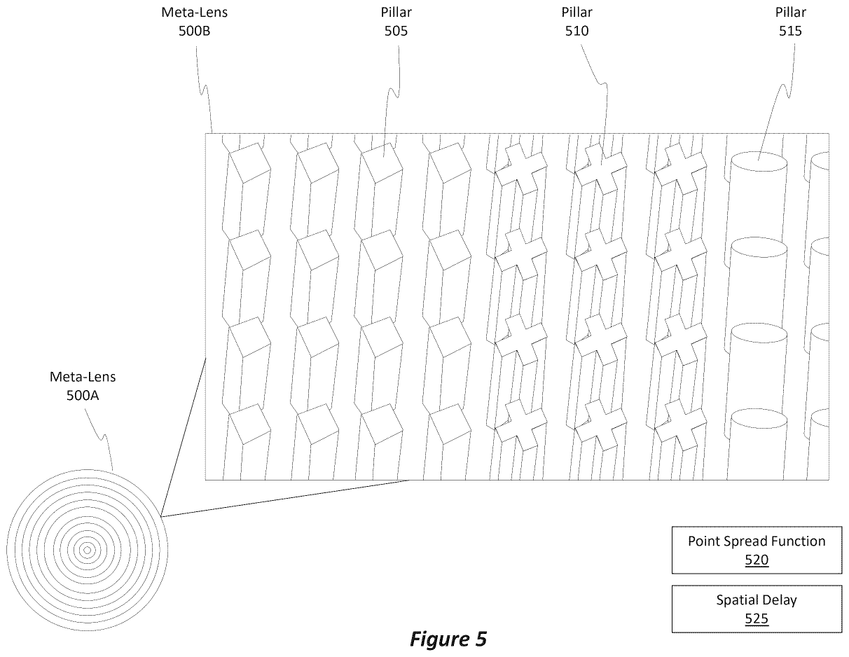

Turning briefly to FIG. 3B, the meta-surface lenslet array 320A is shown. Here, the meta-surface lenslet array 320A is shown as including multiple different lenslets arranged in a manner similar to the manner in which the filter array 305 is arranged. The meta-surface lenslet array 320A is shown as including lenslets 335A, 335B, 335C, 335D, 335E, 335F, 335G, 335H, 335I, 335J, 335K, 335L, 335M, 335N, 335O, and 335P. Each lenslet includes different pillars, as will be discussed later in connection with FIG. 5. A similar configuration is available for the wafer-molded lens discussed herein.

The meta-surface lenslet array 320A (and the wafer-molded lenslet array 320B) includes a plurality of lenslets, and each lenslet includes a corresponding array of pillars. Each array of pillars of each meta-surface lenslet array creates a corresponding point spread function that spatially delays a phase of the LWIR light, resulting in each lenslet focusing a corresponding portion of the LWIR light onto a corresponding set of pixels of the thermal imaging sensor, similar to how a traditional lens operates. FIG. 5 is illustrative.

FIG. 5 shows one example of a meta-lens 500A and a magnified version of the meta-lens, as shown by meta-lens 500B. Recall, the meta-surface lenslet array is formed of a metamaterial. Examples of metamaterials include, but certainly are not limited to, silicon, silicon nitride, germanium, GaAs, zinc selenide, chalcogenide glasses, and so on.

Notice the concentric rings of pillars illustrated in FIG. 5. For instance, meta-lens 500B is shown as including pillars of a first type (e.g., pillar 505 having a rectangular prism shape), pillars of a second type (e.g., pillar 510 having a “+” shape), and pillars of a third type (e.g., pillar 515 having a cylindrical shape). Any different size and shape of pillars can be used to create a point spread function 520 for the light to thereby focus the light in a manner similar to how a lens would focus light. This focusing occurs, however, without a concave or convex lens. Instead, this focusing occurs via use of a flat surfaced or monolithic unit having the differently designed pillars. Thus, each array of pillars of each meta-lens creates a corresponding point spread function 520 that spatially delays (e.g., spatial delay 525) a phase of the LWIR light, resulting in each lenslet focusing a corresponding portion of the LWIR light onto a corresponding set of pixels of the thermal imaging sensor.

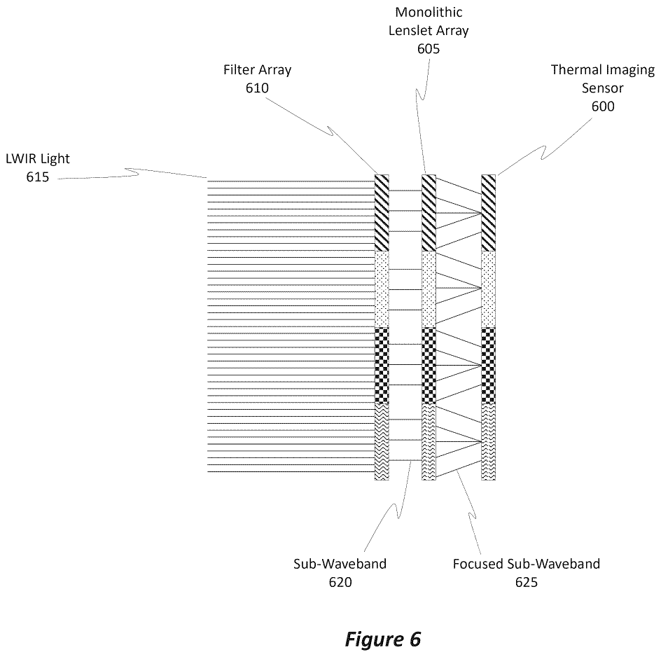

Returning to FIG. 3A, the apparatus mentioned earlier further includes a (single) thermal imaging sensor 325 having multiple different pixel sets 330, such as pixel sets 325A, 325B, 325C, 325D, 325E, 325F, 325G, 325H, 325I, 325J, 325K, 325L, 325M, 325N, 325O, and 325P. These pixel sets 330 are arranged in the same grid-like pattern as the filters and the lenslets. Thus, pixel set 325A is disposed underneath and is covered by lenslet 315A (as well as potentially either one of the meta-surface lenslet array 320A or the wafer-molded lenslet array 320B), which is disposed underneath and is covered by filter 305A. LWIR light is filtered by the filter 305A before reaching the lenslet 315A. The lenslet 315A then focuses the filtered light (potentially onto either one of the meta-surface lenslet array 320A or the wafer-molded lenslet array 320B, which then further focuses the light) onto the pixel set 325A. FIG. 6 provides further details. It should also be noted how each pixel set may include one or more pixels of the thermal imaging sensor.

FIG. 6 shows the apparatus, which includes the thermal imaging sensor 600, the monolithic lenslet array 605, and the filter array 610. The meta-surface lenslet array and/or the wafer-molded lenslet array are omitted in FIG. 6, but one will appreciate how these components could be disposed between the monolithic lenslet array 605 and the thermal imaging sensor 600. The monolithic lenslet array 605 is disposed between the filter array 610 and the single thermal imaging sensor 600. The LWIR light 615 passes first through the filter array 610, thereby forming a number of sub-wavebands (e.g., sub-waveband 620). The filtered LWIR light then passes through the monolithic lenslet array 605 prior to reaching the single thermal imaging sensor 600. The filtered LWIR light passing through the monolithic lenslet array 605 forms focused sub-wavebands, as shown by focused sub-waveband 625, which is focused onto a specific set of one or more pixels of the thermal imaging sensor 600. The different shading reflects the different filter/lenslet/pixel combinations. For instance, at the top of the figure, the blocks having the diagonal line may correspond to the filter 305A, the lenslet 315A, and the pixel set 325A of FIG. 3A. Similarly, the blocks having the dots may correspond to filter 305E, lenslet 315E, and pixel set 325E. The blocks having the square pattern may correspond to filter 305I, lenslet 315I, and pixel set 325I. Finally, the blocks having the wave pattern may correspond to filter 305M, lenslet 315M, and pixel set 325M.

Regarding the characteristics of each pixel set, in some implementations, a pixel pitch of each pixel in each corresponding set of pixels is about 8 microns. In some scenarios, the pixel pitches for thermal arrays is from about 12 microns to about 10 microns. As another option, each corresponding set of pixels includes a set of at least 320 pixels by at least 256 pixels. For instance, with reference to FIG. 3A, the pixel set 325A may include a set of at least 320 pixels by at least 256 pixels.

In some implementations, the number of different sets of pixels is from 4 to 16 (e.g., FIG. 3A shows 16 different pixel sets). The number of different pixel sets will likely be equal to the number of different lenslets, and the number of different lenslets will likely be equal to the number of different filters. As mentioned above, a pixel pitch of pixels in the different sets of pixels is about 8 microns or is at least 8 microns. Of course, different sizes can be used, such as from about 8 microns to about 12 microns.

With reference to FIG. 3A, the plurality of lenslets includes a first lenslet (e.g., lenslet 315A) and a second lenslet (e.g., lenslet 315B). The filter array includes a first optical bandpass filter (e.g., filter 305A) and a second optical bandpass filter (e.g., filter 305B). The first optical bandpass filter (e.g., 305A) is disposed, in a z-direction (where the x-direction and y-direction form the planar region of the filters in FIG. 3A and where the z-direction is perpendicular to that planar region, such as protruding outward from the page of FIG. 3A), above the first lenslet (e.g., 315A).

The second optical bandpass filter (e.g., 305B) is disposed, in the z-direction, above the second lenslet (e.g., 315B). The first optical bandpass filter (e.g., 305A) is structured to permit a first range of wavelengths of the LWIR light to reach the first lenslet (e.g., 315A). The second optical bandpass filter (e.g., 305B) is structured to permit a second range of wavelengths of the LWIR light to reach the second lenslet (e.g., 315B). The first lenslet (e.g., 315A) includes a first array of pillars arranged in a first configuration to focus the first range of wavelengths to a first set of pixels (e.g., 325A) of the thermal imaging sensor. The second lenslet (e.g., 315B) includes a second array of pillars arranged in a second configuration to focus the second range of wavelengths to a second set of pixels (e.g., 325B) of the thermal imaging sensor.

Returning to FIG. 2A, the apparatus 200 thus disperses long-wave infra-red (LWIR) light having wavelengths spanning from about 8 microns to about 14 microns into a plurality of sub-wavebands via use of a flat-surfaced lenslet array (e.g., the focusing element 200A) that (i) has a low profile z-height, (ii) has lenslets that are substantially immediately proximate to one another, and (iii) operates on the LWIR light in a spatial and spectral manner. As mentioned earlier, however, the principles can also be used in the far IR range, which extends beyond about 12 microns. Also, the focusing element 200A may include any one or more of the monolithic lenslet array 210, the meta-lens 240 of FIG. 2B, and/or the wafer-molded lens 245 of FIG. 2C.

Apparatus 200 includes a filter array 205, which includes a plurality of optical bandpass filters arranged in a pattern. Each optical bandpass filter in the filter array is structured to spectrally split the LWIR light into a corresponding sub-waveband. A combination of each corresponding sub-waveband forms the plurality of sub-wavebands. The plurality of sub-wavebands covers at least half of the wavelengths of the LWIR light.

Apparatus 200 may include the flat-surfaced lenslet array (e.g., monolithic lenslet array 210), which includes a plurality of lenslets also arranged in the pattern and which is aligned with the filter array such that each optical bandpass filter in the filter array is aligned with a corresponding lenslet in the plurality of lenslets. The monolithic lenslet array 210 includes lenslets that are structured as DOEs, which are made of features that diffract or focus light.

Apparatus 200 may additionally or alternatively include the meta-lens 240, which is configured to also have multiple lenslets. Each of these lenslets is structured to include a corresponding array of pillars designed to focus light. Each array of pillars of each lenslet creates a corresponding point spread function that spatially delays a phase of the LWIR light, resulting in each lenslet generating a focused beam of a corresponding portion of the LWIR light. Those beams of LWIR light are then directed to corresponding pixel sets of the image sensor 215.

The flat-surfaced lenslet array may be formed, as one example, of a metamaterial. Optionally, the plurality of sub-wavebands covers at least 75% of the wavelengths of the LWIR light. As another option, the plurality of sub-wavebands covers at least 90% of the wavelengths of the LWIR light. In some cases, the plurality of sub-wavebands covers 100% of the wavelengths of the LWIR light. Thus, anywhere from about 50% to about 100% of the LWIR light is usable by the apparatus 200.

In some implementations, the plurality of sub-wavebands covers wavelengths of the LWIR light from about 8 microns in wavelength up to at least about 12 microns in wavelength. Optionally, each sub-waveband covers a range spanning at least 0.25 microns in wavelength. Other ranges can be used, however.

As another description, apparatus 200 spatially and spectrally disperses long-wave infra-red (LWIR) light into a plurality of sub-wavebands. Apparatus 200 may include a thermal imaging sensor 215 and a filter array 205, which includes a plurality of optical bandpass filters arranged in a pattern.

Each optical bandpass filter in the filter array is structured to spectrally split the LWIR light into a corresponding sub-waveband to form the plurality of sub-wavebands. Each optical bandpass filter in the filter array is spatially positioned proximate to at least two other optical bandpass filters in the filter array.

Apparatus 200 further includes a monolithic lenslet array 210, which includes a plurality of lenslets also arranged in the pattern and which is aligned with the filter array such that each optical bandpass filter in the filter array is aligned with a corresponding lenslet in the plurality of lenslets. The monolithic lenslet array 210 operates as a DOE.

Apparatus 200 may also include the meta-lens 240, which also includes a plurality of lenslets. Each lenslet in this plurality of lenslets is structured to include a corresponding array of pillars. Each array of pillars of each lenslet creates a corresponding point spread function that spatially delays a phase of the LWIR light, resulting in each lenslet focusing a corresponding portion of the LWIR light onto a corresponding set of pixels of the thermal imaging sensor.

Returning to FIG. 1, service 105 uses the apparatus 105A to obtain a readout 125 from the image sensor of the apparatus 105A. In some implementations, a second thermal imager is disposed on the ER system 110. This second thermal imager can generate a thermal image 130. Thus, it should be noted how at least two different thermal images can be produced. The readout 125 is generated by a first thermal imager (e.g., the apparatus 105A) and produces one or more thermal images, and the thermal image 130 is generated by a second, different thermal imager disposed on the ER system 110.

Service 105 is configured to use the readout 125 and to break or split the readout 125 into a plurality of different images 135, where this splitting/breaking action is performed based on the different spectral wavelengths that are recorded in the readout 125. For instance, with reference to FIG. 3A, the pixel set 325A can create a first image, the pixel set 325B can create a second image, the pixel set 325B can create a third image, and so on. In the example of FIG. 3A, sixteen different images can be created from the single readout of the single thermal imaging sensor 325.

Thus, service 105 obtains a single readout 125 (or perhaps multiple readouts) of a thermal imaging sensor. As described above, the thermal imaging sensor includes a plurality of different sets of pixels, and each respective set of pixels captures a different corresponding range of wavelengths of long-wave infra-red (LWIR) light.

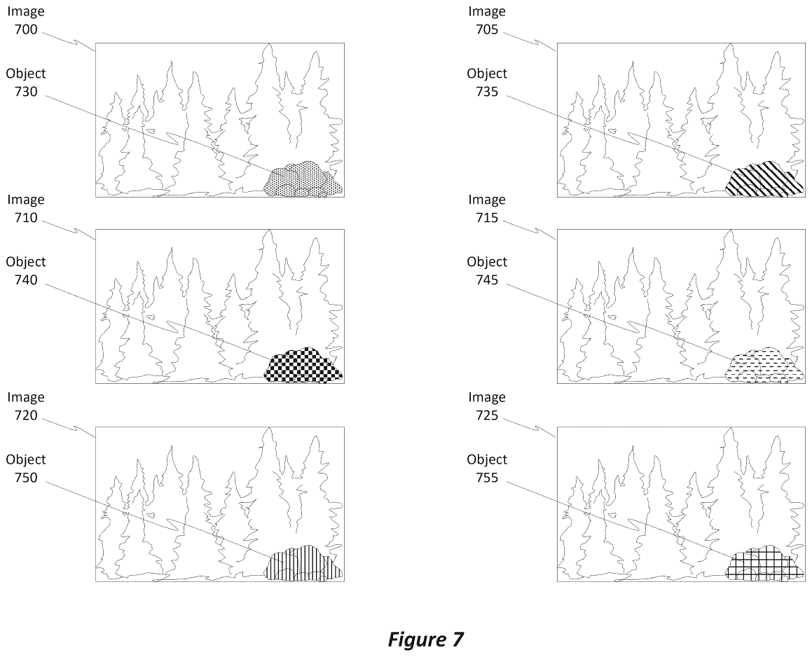

In at least some embodiments, service 105 then generates a number of images 135 using the single readout. The number of images that are generated can be equal to a number of the different sets of pixels, although a different number of images can be generated. For instance, in some cases, the number of images that are generated does not equal the number of different sets of pixels in the apparatus. In this example scenario, however, if there are 16 different pixel sets, then 16 different images may be produced. Each one of the generated images reflects a same scene using a corresponding one of the different ranges of wavelengths of the LWIR light. For instance, with reference to FIG. 3A, the pixel set 325A captures a scene. Pixel set 325B captures the same scene. Pixel set 325C also captures the same scene. These different pixel sets capture the same scene at different wavelengths of the LWIR light. FIG. 7 is illustrative. Optionally, the embodiments can increase framerate if certain bands are determined to be more important. For instance, the framerate can be increased or modified by selecting a subset of the bands for use while deselecting other bands that will not be used.

In some implementations, the embodiments generate fewer images than the number of different sets of pixels. For instance, if the number of pixel sets is “N,” the number of images can be N/2 or N/4 or any number of other images. Each of these images may be produced with a corresponding sensor capture. Optionally, some embodiments may discard portions of the data to meet memory constraints. While this option might reduce effective framerate, this option can still provide substantial benefits in terms of cost reduction. In some scenarios, the embodiments might operate by using multiple readouts to obtain images corresponding to each of the LWIR ranges.

FIG. 7 shows six example images, such as images 700, 705, 710, 715, 720, and 725. Although only six images are shown in FIG. 6, one will appreciate how 16 images would be produced if the apparatus illustrated in FIG. 3A were used.

The pixel set 325A of FIG. 3A may be used to generate image 700; the pixel set 325B of FIG. 3A may be used to generate image 705; the pixel set 325C of FIG. 3A may be used to generate image 710; the pixel set 325D of FIG. 3A may be used to generate image 715; the pixel set 325E of FIG. 3A may be used to generate image 720; and the pixel set 325F of FIG. 3A may be used to generate image 725. As emphasized above, although only 6 images are shown in FIG. 7, one will appreciate how the number of distinct images may correspond to the number of different pixel sets being used (e.g., in FIGS. 3A, 16 different pixel sets are being used).

In FIG. 1, service 105 then identifies, within the images 135, an object 140 that is represented in all (or at least one or more) of the images and that is represented across the different ranges of wavelengths (or at least one or more of the wavelengths). For instance, the scene may include a rock, which is representative of the object 140. It should be noted how some of the images may not represent, or may not represent to a threshold level of clarity, the object. Thus, in accordance with the disclosed principles, one, some, or all of the images may portray the object. It is not a requirement that all of the images portray the object; instead, at least one of the images is required to portray the object.

In FIG. 7, notice how each of the images reflects the same scene. It is particularly noted, however, how each of the images reflects the same scene using a different wavelength of the LWIR light. Also, each of the images shows the same object, which is a rock, as shown by the objects 730, 735, 740, 745, 750, and 755. As emphasized above, it is not a requirement that every image portray the object.

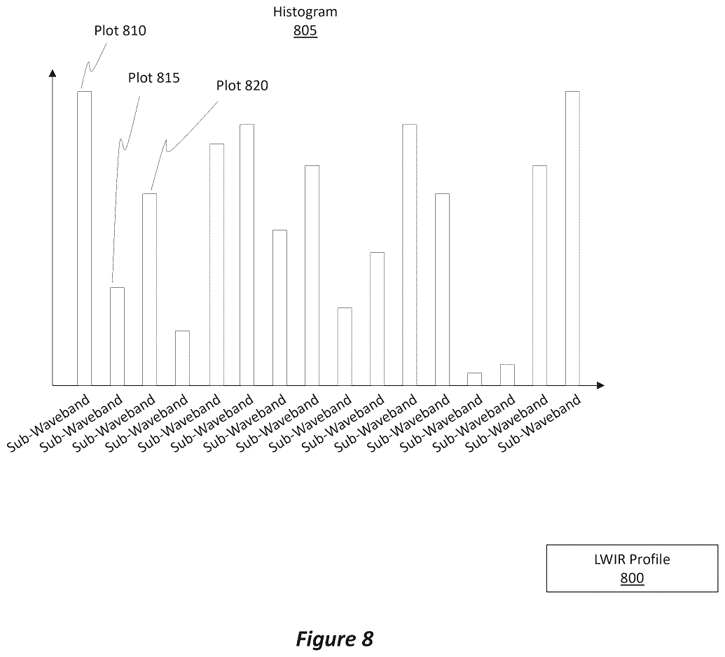

In FIG. 1, service 105 uses one or more of the images 135, which reflect the different ranges of wavelengths, to identify a LWIR profile 145 for the object. FIG. 8 is illustrative.

FIG. 8 shows an LWIR profile 800 for the object (e.g., rock) detected in the scene. In this example scenario, the LWIR profile 800 is implemented in (or at least includes) a histogram 805 of the different sub-wavebands that are reflected in the images (for the particular object). The images can be segmented to extract the pixels corresponding to the object. Those extracted pixels can then be analyzed to generate the histogram 805. Thus, to be clear, the histogram 805 corresponds to a specific object identified within the scene and does not necessarily correspond to the entire scene.

In this example scenario, 16 different images were generated from the 16 different pixel sets in the earlier example. Each image reflects the scene at a different sub-waveband. Thus, histogram 805 includes 16 different plots to reflect the total combination of the sub-wavebands that were obtained (the total number of images that were obtained). The specific portion of the images reflective of the object can be analyzed to detect the pixel characteristics of the object at that corresponding sub-waveband. The results of the image analysis are shown in the histogram 805.

For instance, object 730 in image 700 can portray the first plot (plot 810) of sub-waveband characteristics in FIG. 8. Object 735 in image 705 can portray the second plot (e.g., plot 815) of sub-waveband characteristics in FIG. 8. Object 740 in image 710 can portray the third plot (e.g., plot 820) of sub-waveband characteristics in FIG. 8. Object 745 in image 715 can portray the fourth plot of sub-waveband characteristics in FIG. 8. Object 750 in image 720 can portray the fifth plot of sub-waveband characteristics in FIG. 8. Object 755 in image 725 can portray the sixth plot of sub-waveband characteristics in FIG. 8. The combination of the different plots can thus represent the object's LWIR profile 800. That is, the rock object in the images of FIG. 7 has the LWIR profile represented by the histogram 805 of FIG. 8.

In FIG. 1, service 105 then determines a type of the object 140 by matching the identified LWIR profile 145 with a previously saved LWIR profile established for objects of that type. For instance, FIG. 1 shows a repository 115A that includes any number of previously saved LWIR profiles 115B. These profiles may have been previously learned by the ML engine 115. For example, ML engine 115 may have learned that rock objects have a first LWIR profile and grass objects have a second LWIR profile. Service 105 can determine the LWIR profile 145 of the object 140 (e.g., using the images 135) and then match that determined LWIR profile 145 with a preexisting LWIR profile in the repository 115A to determine the type for the object 140.

By way of further detail, service 105 may not initially be able to determine that the object 730 in FIG. 7 is a rock. However, service 105 can determine the LWIR profile 800 of the rock object 730. Using this determined LWIR profile 800 (which service 105 still does not recognize as corresponding to a rock), service 105 can query the repository 115A in an attempt to find a pre-existing LWIR profile that has a threshold level of similarity to the LWIR profile 800. If a match is found, then service 105 can determine what the pre-existing LWIR profile corresponded to. The repository 115A will include metadata detailing which LWIR profile corresponds to which type of object. This, the identified LWIR profile in the repository 115A will include metadata indicating that it is for a rock. Using the metadata, service 105 can then determine that the LWIR profile 800 for the object is that of a rock. Thus, service 105 can determine that the object 730 in FIG. 7 is a rock based on the identified match between the two LWIR profiles.

Service 105 can then colorize a different thermal image (e.g., thermal image 130) of the scene. Colorizing the different thermal image of the scene includes colorizing the object as represented within that scene based on the determined type for the object. The colorized image 150 is the resulting image that is colorized.

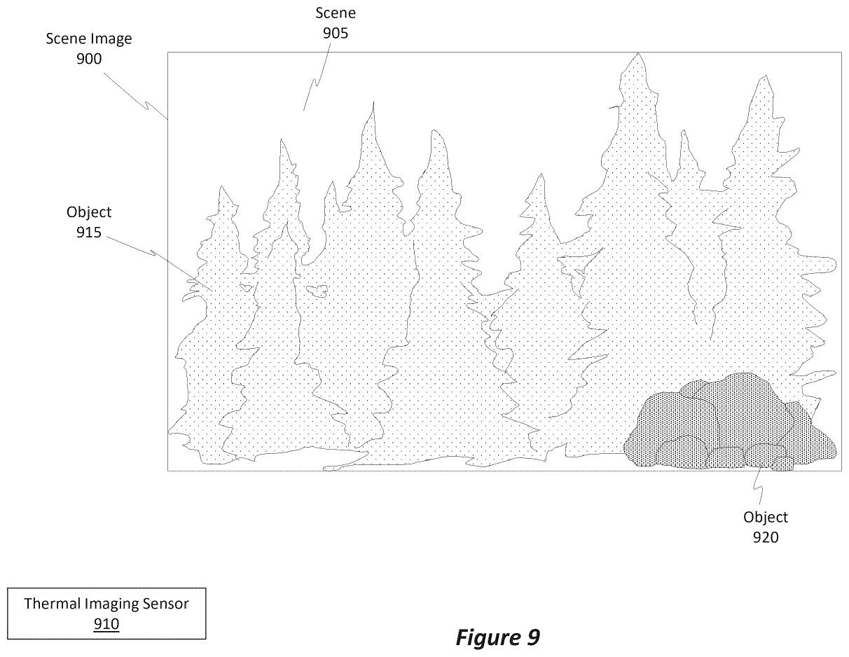

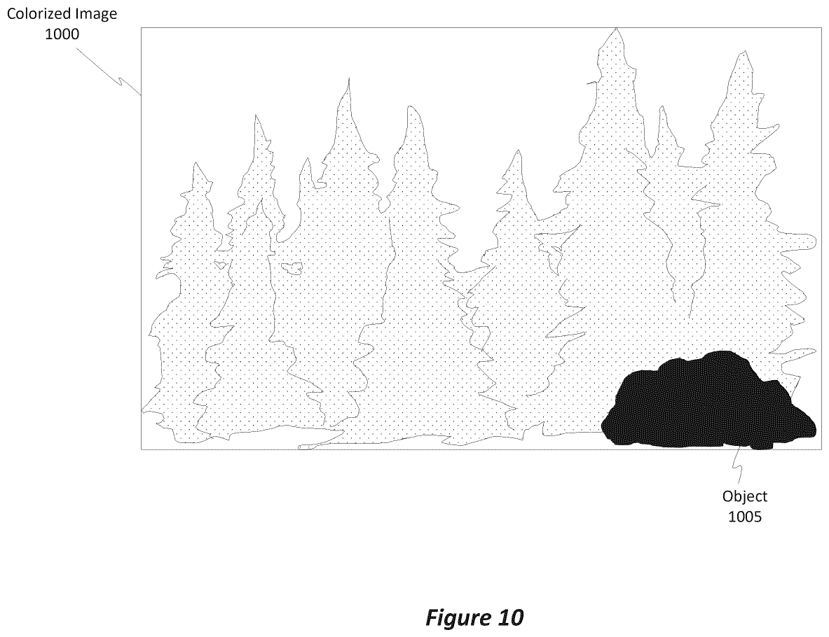

For instance, FIG. 9 shows a scene image 900 of a scene 905. This scene image 900 can be the different thermal image mentioned previously (e.g., thermal image 130 of FIG. 1). Thus, scene image 900 can be one that is generated by a different thermal imaging sensor 910 than the one included in apparatus 200 of FIG. 2. Scene image 900 is shown as depicting a first object 915 and a second object 920. Service 105 is able to colorize the scene image 900 in the manner described above. For instance, FIG. 10 shows a colorized image 1000 in which the object 1005 has been colorized based on the determined LWIR profile for that object. This colorizing operation is performed using the AI algorithm (e.g., ML engine 115), which facilitates the generation of the LWIR profile 145 and which facilitates the match and selection between the different LWIR profiles to determine the object's type.

Returning to FIG. 1, the machine learning (ML) engine 115 generated the previously saved LWIR profile for the object 140 (e.g., one of the LWIR profiles 115B). The ML engine 115 can be tuned based on an environment classification of the scene. As one example, the environment classification can be one of an urban environment or a rural environment. The environment classification can be an outdoor environment or an indoor environment. The environment classification can include any classification, such as an office environment, home environment, vehicle environment, desert environment, forest environment, mountain environment, water environment, and so on without limit. Optionally, the identified LWIR profile 145 is identified by generating a histogram for the object using the images, as was described in connection with FIG. 8.

In some implementations, colorizing the object includes assigning a single color to the object. In some implementations, a second object is included in the scene. The second object may be of the same type as the original object. If so, the second object is colorized using a same color as the original object in the different thermal image. If the second object is a different type, then a different LWIR profile will be determined and identified for the second object, and a different color can be used to colorize the second object.

### EXAMPLE METHODS

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

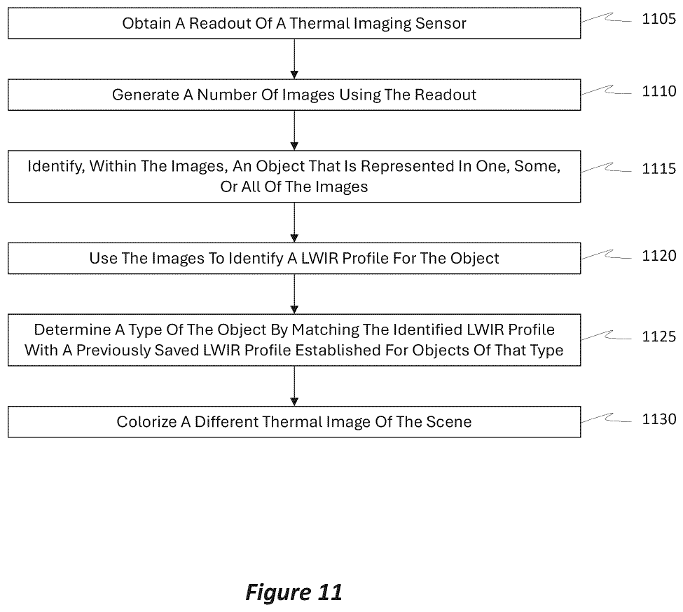

Attention will now be directed to FIG. 11, which illustrates a flowchart of an example method 1100 for using an AI algorithm to colorize thermal images. Method 1100 can be implemented within architecture 100 of FIG. 1 and can be performed by service 105.

Method 1100 includes an act 1105 of obtaining a single readout of a thermal imaging sensor. The thermal imaging sensor includes a plurality of different sets of pixels, and each respective set of pixels captures a different corresponding range of wavelengths of long-wave infra-red (LWIR) light. For instance, the apparatus 200 of FIG. 2 can be used and can include the thermal imaging sensor mentioned here.

Act 1110 includes generating a number of images using the readout, which may be a single readout or which may include multiple readouts. The number of images that are generated may be equal to a number of the different sets of pixels. In some scenarios, the number of images that are generated does not equal the number of different sets of pixels included in the thermal imaging sensor. Each one of the images reflects a same scene using a corresponding one of the different ranges of wavelengths of the LWIR light. In some scenarios, the number of images is an even number. Optionally, the number can be an odd number. Typically, the number of different sets of pixels is a minimum of 4 sets. In some cases, however, the number of images is at least 2.

Act 1115 includes identifying, within one or more of the images, an object. This object is represented in one, some, or all of the images and is represented across one, some, or all of the different ranges of wavelengths.

Act 1120 includes using one or more of the images, which reflect the different ranges of wavelengths, to identify an LWIR profile for the object. The LWIR profile can include a histogram generated from the different images. Optionally, the LWIR profile that is identified for the object using the one or more images is based on a number of images that is equal to the number of different sets of pixels included in the thermal imaging sensor. In other scenarios, the number of images used to identify the LWIR profile is different (e.g., more or less) than the number of different sets of pixels. In some scenarios, one or more of the images may not include adequate pixel content to be useful in generating or identifying the LWIR profile, thus, in some scenarios, not all of the images may be used.

Act 1125 includes determining a type of the object by matching the identified LWIR profile with a previously saved LWIR profile established for objects of that type. Optionally, a machine learning (ML) engine determines the type of the object based on an environment classification the ML engine has with respect to the scene.

Act 1130 includes colorizing a different thermal image of the scene. The process of colorizing the different thermal image of the scene includes colorizing the object as represented within that scene based on the determined type for the object. The computer system implemented method 1100 can include a second thermal imaging sensor, and the second thermal imaging sensor generates the different thermal image. Optionally, other sensor types can be used, such as visible light sensors, UV sensors, low light sensors, or other types of thermal sensors. The embodiments can overlay content obtained from an image generated by one sensor type (e.g., the thermal sensor) onto content obtained from an image generated by a different sensor type (e.g., a low light sensor or a visible light sensor). This overlaying can occur provided there is enough feature matching to align the content from the two different image types. Coloring and other image enhancements to other image types can thus be employed using the disclosed principles.

### Example Computer/Computer Systems

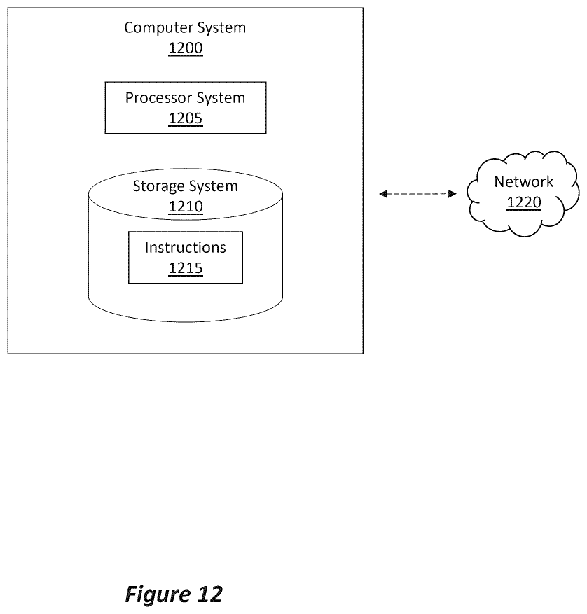

Attention will now be directed to FIG. 12 which illustrates an example computer system 1200 that may include and/or be used to perform any of the operations described herein. For instance, computer system can implement service 105 of FIG. 1. Computer system can also take the form of ER system 110.

Computer system 1200 may take various different forms. For example, computer system 1200 may be embodied as a tablet, a desktop, a laptop, a mobile device, or a standalone device, such as those described throughout this disclosure. Computer system 1200 may also be a distributed system that includes one or more connected computing components/devices that are in communication with computer system 1200.

In its most basic configuration, computer system 1200 includes various different components. FIG. 12 shows that computer system 1200 includes a processor system 1205, which may include one or more processor(s) (aka a “hardware processing unit”) and a storage system 1210.

Regarding the processor(s) of processor system 1205, it will be appreciated that the functionality described herein can be performed, at least in part, by one or more hardware logic components (e.g., the processor(s)). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 1200. The different components, modules, engines, and services described herein may be implemented as objects or processors that execute on computer system 1200 (e.g. as separate threads).

Storage system 1210 may be physical system memory, which may be volatile, non-volatile, or some combination of the two. The term “memory” may also be used herein to refer to non-volatile mass storage such as physical storage media. If computer system 1200 is distributed, the processing, memory, and/or storage capability may be distributed as well.

Storage system 1210 is shown as including executable instructions 1215. The executable instructions 1215 represent instructions that are executable by the processor(s) of processor system 1205 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1200 may also be connected (via a wired or wireless connection) to external sensors (e.g., one or more remote cameras) or devices via a network 1220. For example, computer system 1200 can communicate with any number devices or cloud services to obtain or process data. In some cases, network 1220 may itself be a cloud network. Furthermore, computer system 1200 may also be connected through one or more wired or wireless networks to remote/separate computer systems(s) that are configured to perform any of the processing described with regard to computer system 1200.

A “network,” like network 1220, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1200 will include one or more communication channels that are used to communicate with the network 1220. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
obtaining a readout of a thermal imaging sensor, wherein the thermal imaging sensor includes a plurality of different sets of pixels, and wherein each respective set of pixels captures a different corresponding range of wavelengths of long-wave infra-red (LWIR) light;
generating a number of images using the readout, wherein each one of the images reflects a same scene using a corresponding one of the different ranges of wavelengths of the LWIR light;
identifying, within the images, an object that is represented in at least some of the images and is represented across at least some of the different ranges of wavelengths;
using one or more of the images, which reflect the different ranges of wavelengths, to identify an LWIR profile for the object;
determining a type of the object by matching the identified LWIR profile with a previously saved LWIR profile established for objects of that type; and
colorizing a different thermal image of the scene, wherein colorizing the different thermal image of the scene includes colorizing the object as represented within that scene based on the determined type for the object.

2. The method of claim 1, wherein a machine learning (ML) engine generated the previously saved LWIR profile.

3. The method of claim 2, wherein the ML engine is tuned based on an environment classification of the scene.

4. The method of claim 3, wherein the environment classification is one of an urban environment or a rural environment.

5. The method of claim 3, wherein the environment classification is an outdoor environment.

6. The method of claim 1, wherein the different thermal image is generated by a different thermal imaging sensor.

7. The method of claim 1, wherein the identified LWIR profile is identified by generating a histogram for the object using the images.

8. The method of claim 1, wherein the number of images that are generated does not equal a number of the different sets of pixels.

9. The method of claim 1, wherein the LWIR profile that is identified for the object using the one or more images is based on a number of images that is equal to a number of different sets of pixels included in the thermal imaging sensor.

10. The method of claim 1, wherein a pixel pitch of pixels in the different sets of pixels is at least 8 microns.

11. The method of claim 1, wherein colorizing the object includes assigning a single color to the object.

12. The method of claim 1, wherein a second object is included in the scene, wherein the second object is of the same type as said object, and wherein the second object is colorized using a same color as said object in the different thermal image.

13. A computer system comprising:
a processor system; and
a storage system that stores instructions that are executable by the processor system to cause the computer system to:
obtain a readout of a thermal imaging sensor, wherein the thermal imaging sensor includes a plurality of different sets of pixels, and wherein each respective set of pixels captures a different corresponding range of wavelengths of long-wave infra-red (LWIR) light;
generate a number of images using the readout, wherein each one of the images reflects a same scene using a corresponding one of the different ranges of wavelengths of the LWIR light;
identify, within the images, an object that is represented in at least some of the images and is represented across at least some of the different ranges of wavelengths;
use the images, which reflect the different ranges of wavelengths, to identify an LWIR profile for the object;
determine a type of the object by matching the identified LWIR profile with a previously saved LWIR profile established for objects of that type; and
colorize a different thermal image of the scene, wherein colorizing the different thermal image of the scene includes colorizing the object as represented within that scene based on the determined type for the object.

14. The computer system of claim 13, wherein the number of images is an even number.

15. The computer system of claim 13, wherein a machine learning (ML) engine determines the type of the object based on an environment classification the ML engine has with respect to the scene.

16. The computer system of claim 13, wherein the computer system includes a second thermal imaging sensor, the second thermal imaging sensor generating the different thermal image.

17. The computer system of claim 13, wherein the number of different sets of pixels is a minimum of 4 sets.

18. An extended reality (ER) system comprising:
a processor system; and
a storage system that stores instructions that are executable by the processor system to cause the ER system to:
obtain a readout of a thermal imaging sensor, wherein the thermal imaging sensor includes a plurality of different sets of pixels, and wherein each respective set of pixels captures a different corresponding range of wavelengths of long-wave infra-red (LWIR) light;
generate a number of images using the readout, wherein the number of images that are generated equals a number of the different sets of pixels, and wherein each one of the images reflects a same scene using a corresponding one of the different ranges of wavelengths of the LWIR light;
identify, within the images, an object that is represented in at least some of the images and is represented across at least some of the different ranges of wavelengths;
use the images, which reflect the different ranges of wavelengths, to identify a LWIR profile for the object;
determine a type of the object by matching the identified LWIR profile with a previously saved LWIR profile established for objects of that type; and
colorize a different thermal image of the scene, wherein colorizing the different thermal image of the scene includes colorizing the object as represented within that scene based on the determined type for the object.

19. The ER system of claim 18, wherein the number of images is at least 2.

20. The ER system of claim 18, wherein a machine learning (ML) engine determines the type of the object based on an environment classification the ML engine has with respect to the scene.
